(19) United States
(12) Patent Application Publication
(10) Pub. No.: US 2023/0389529 A1
(43) Pub. Date: Dec. 7, 2023

(54) ADAPTIVE FEEDING OF AQUATIC ORGANISMS IN AN AQUACULTURE ENVIRONMENT

(71) Applicant: Aquabyte, Inc., San Francisco, CA (US)

(72) Inventor: Bryton SHANG, San Francisco, CA (US)

(21) Appl. No.: 17/831,053

(22) Filed: Jun. 2, 2022

(51) Int. Cl. A01K 61/85; H04L 67/12

(52) U.S. Cl. CPC A01K 61/85; H04L 67/12

(57) ABSTRACT

Adaptive feeding of aquatic organisms in an aquaculture environment. Sensor data is received from an aquaculture environment sensor. The sensor data reflects environmental conditions in the aquaculture environment. Feed selection data is determined based on the sensor data. The feed selection data is sent to a feed controller thereby causing the feed controller to dispense one or more feed materials into the aquaculture environment. Alternatively, the feed selection data is sent to an electronic feed ordering system thereby causing an aquaculture feed provider to ship a feed material.

### BACKGROUND

The disclosed subject matter relates to a system and method for adaptive feeding of aquatic organisms in an aquaculture environment. Aquaculture is the farming of aquatic organisms (e.g., fish) in both coastal and inland areas involving interventions in the rearing process to enhance production. Aquaculture has experienced dramatic growth in recent years. The Food and Agriculture Organization (FAO) of the United Nations has estimated that aquaculture accounts for at least half of the world's fish that is used for food. The rise of aquaculture has fostered interest in techniques that improve the production processes in fish farms.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF DRAWINGS

Various examples in accordance with the present disclosure will be described with reference to the drawings, in which:

FIG. 1 illustrates an aquaculture environment for adaptive feeding of aquatic organisms, according to some examples.

FIG. 2 is a flowchart of a method for adaptive feeding of aquatic organisms in an aquaculture environment, according to some examples.

FIG. 3 illustrates an aquaculture environment for adaptive feeding of aquatic organisms, according to some examples.

FIG. 4 illustrates a computer system that can be used in an implementation an adaptive feeding computer system, according to some examples.

### DETAILED DESCRIPTION

Traditional aquaculture feeding systems dispense a single type of feed material. Dispensing can be controlled to turn on feeding and turn off feeding. However, an aquaculture cage can contain aquatic organisms at different life cycle stages. For optimal development, the aquatic organisms at each stage can require feed with different nutrient composition. For example, younger salmonids can require more protein in their feed for growth and adult salmonids can require more lipids to increase fat stores in their bodies. Periodically dispensing a single type of feed into an aquaculture cage that contains a mix of aquatic organisms at different life stages can be sub-optimal for rearing the aquatic organisms for harvest.

Deficiencies of traditional aquaculture feeding systems are addressed by the disclosed techniques for adaptive feeding of aquatic organisms in an aquaculture environment. The techniques encompass a method implementation and a system implementation.

In some examples, the method is performed by one or more computing devices. The method includes the step of receiving sensor data from one or more aquaculture environment sensors. The sensor data reflects environmental conditions in the aquaculture environment. The aquaculture environment comprises an open water aquatic organism farming enclosure containing aquatic organisms. The method further comprises the step of determining feed selection based on the sensor data. The method additionally includes the step of sending feed selection data to a feed controller to cause the feed controller to dispense one or more feed materials into the aquaculture environment.

In some examples, the system includes one or more computing devices to implement an adaptive feeding computer system. The adaptive feeding computer system is programmed or configured with instructions which when executed cause the adaptive feeding computer system to perform the method.

The system and method will now be described with respect to the figures.

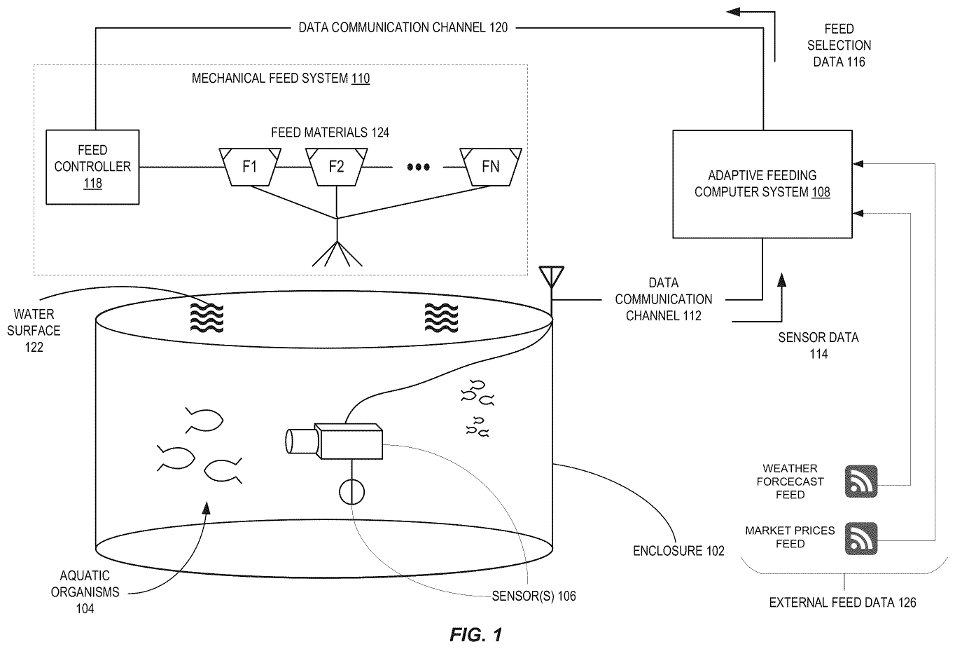

FIG. 1 depicts an example aquaculture environment, according to some examples. The environment includes aquatic organism enclosure 102, aquatic organisms 104, set of one or more sensors 106, adaptive feeding computer system 108, and mechanical feed system 110.

Enclosure 102 can be framed by a plastic or steel cage that provides a substantially conical, cubic, cylindrical, spherical, or hemispherical shape. Enclosure 102 can hold aquatic organisms 104 of a particular type (e.g., Atlantic salmon or other fish specifies farmed for food for consumption by humans) The maximum number of aquatic organisms 104 held can vary depending on various factors such as the size of enclosure 102 and the maximum stocking density of the particular type of aquatic organism being farmed. For example, enclosure 102 for Atlantic salmon can be 50 meters in diameter, 20-50 meters deep, and hold up to approximately 200,000 salmon assuming a maximum stocking density of 10 to 25 kg/m3. While enclosure 102 can be a net pen or sea-cage located in the open sea or in open water, enclosure 102 can be a fish farm pond, tank, or other fish farm enclosure.

Set of sensors 106 can include a monocular or stereo vision underwater camera immersed underwater in enclosure 102. The underwater camera can use visible light to capture images or video of aquatic organisms 104 moving (e.g., swimming) freely in enclosure 102. The captured images or video can provide pixel information to adaptive feeding computer system 108 from which quantitative information can be extracted by system 108 and analyzed for object recognition using computer vision techniques.

No particular type or configuration of the underwater camera is required. For example, the underwater camera can be an approximately 12-megapixel color or monochrome underwater camera with a resolution of approximately 4096 pixels by 3000 pixels, and a frame rate of 1 to 8 frames per second. Although different underwater cameras with different capabilities can be used according to the requirements of the implementation at hand.

A lens of the underwater camera can be selected based on an appropriate baseline and focal length to capture images of aquatic organisms 104 in enclosure 102 moving in front of the lens where the aquatic organisms are close enough to the lens for proper pixel resolution and feature detection in the captured image, but far enough away from the lens such that a single aquatic organism can fit entirely in an image or video frame. For example, an 8-millimeter focal length lens with high line pair count (1 p/mm) can be used such that the pixels can be resolved. The baseline of the underwater camera can have greater variance such as, for example, within the range of 6 to 12-millimeter baseline.

The underwater camera can be used to capture images or video of objects underwater in enclosure 102 including aquatic organisms 104 being farmed, pests (e.g., sea lice), feed (e.g., uneaten feed pellets), predators that have managed to breach enclosure 102, algae or other invasive organisms, or other objects in enclosure 102. The captured images or video can be sent over data communication channel 112 as sensor data 114 to adaptive feeding computer system 108 for analysis by system 108 using computer vision techniques. The computer vision techniques can be based on machine learning such as, for example, one or more convolutional neural networks trained to extract certain features from input images or video captured by the underwater camera.

The analysis conducted by the computer vision techniques can be for various reasons including to provide as input to a module of system 108 to determine feed selection data 116 to send to feed controller 118 of feed system 110 via data communication channel 120. For example, the analysis conducted by the computer vision techniques of system 108 can be one or more of: biomass estimation of aquatic organisms 104, growth analysis of aquatic organisms 104, feed conversion, sea lice detection or counting, uneaten feed pellet detection or counting, motion analysis of aquatic organisms 104 for health or disease, or other environmental analysis based on images or video captured by the underwater camera.

Sensors 106 can include one or more other sensors for use below water surface 122 of enclosure 102. Such an underwater sensor can measure one or more of water temperature, dissolved oxygen, salinity, chlorophyll, blue-green algae, turbidity, colored dissolved organic matter, or other underwater environmental condition of water in enclosure 102. Sensors 106 can include one or more above-water sensors for use above water surface 122 of or near enclosure 102. Such an above-water sensor can measure one or more air temperature, wind speed, wind direction, barometric pressure, relative humidity, or other above-water environmental condition at or near enclosure 102. Measurement data reflecting measurements made by an underwater sensor or an above-water sensor can be sent to system 108 via data communication channel 112. For example, individual measurements or aggregates thereof made by an underwater sensor or an above-water sensor can be sent to system 108 as time series data either in real-time or in batches (periodically).

An underwater sensor can be attached to the underwater camera or affixed to enclosure 102 under water surface 122. An above-water sensor can be affixed to enclosure above water surface 122. A sensor (the underwater camera, other underwater sensor, or an above-water sensor) can be communicatively coupled to adaptive feeding computer system 108 by data communication channels 112. Data communications channel 112 can include one or more of any suitable wired or wireless data communication channels such as, for example, ETHERNET, USB, FIREWIRE, CAN-BUS, or other wired data communication technology, or 2G, 3G, 4G, 5G, LTE, WI-FI, WIMAX, BLUETOOTH, satellite-based, or other wireless data communication technology.

While adaptive feeding computer system 108 is depicted in FIG. 1 outside of enclosure 102, it is possible for some or all of system 108 to implemented at one or more of sensors 106 (e.g., at the underwater camera that is configured with computing capabilities). It is also possible for some or all of system 108 to implemented by a non-sensor computing appliance that is attached to or affixed to enclosure 102. Some or all of system 108 can be implemented away from enclosure 102 such as at a nearby barge or boat or at a data center or other computing hosting facility (e.g., in the “cloud”). Some or all of system 108 can be implemented at feed system 110 such as, for example, as part of feed controller 118.

The underwater camera can be attached to a winch system (not depicted). The winch allows the underwater camera to be relocated underwater in enclosure 102. This allows the underwater camera to capture images or video of aquatic organisms 104 in enclosure 102 from different locations within enclosure 102. For example, the winch can allow the underwater camera to move around the perimeter of enclosure 102 and at various depths within enclosure 102. The winch can also allow control of pan and tilt of the underwater camera.

The winch can be operated manually by a human controller such as, for example, by directing user input to a winch control system located above water surface 122. In addition, or alternatively, the winch can operate autonomously according to a winch control program configured to adjust the location of the camera underwater within enclosure 102. The autonomous winch control system can adjust the location of the underwater camera according to a series of predefined or pre-programmed adjustments or according to detected signals in enclosure 102 that indicate better or more optimal locations within enclosure 102 for capturing images or video of aquatic organisms 104 relative a current position or orientation of the underwater camera.

A variety of signals can be used such as, for example, machine learning and computer vision techniques applied to images or video captured by the underwater camera to detect schools or clusters of aquatic organisms 104 currently distant from the underwater camera such that a location that is closer to the school or cluster can be determined and the location, tilt, or pan of the underwater camera adjusted to capture more suitable images of aquatic organisms 104.

The same or different techniques can be used to automatically determine that the underwater camera should remain or linger in a current location or orientation because the underwater camera is currently in a good position to capture suitable images of aquatic organisms 104.

Instead of using the winch to position the underwater camera within enclosure 102, the housing of the underwater camera can include underwater propulsion mechanisms such as propellers or water jets. In this case, the underwater camera can move within enclosure 102 autonomously as in a self-driving fashion. Also in this case, the underwater camera can include components and software to control autonomous navigation such as underwater LiDAR and computer vision-software.

While the underwater camera can operate using natural light (sunlight), an ambient lighting apparatus can be attached to the underwater camera or otherwise located within enclosure 102. For example, the light apparatus can illuminate a volume of water in front of the underwater camera lens with ambient lighting in the blue-green spectrum (450 nanometers to 570 nanometers). This spectrum can be used to increase the length of the daily sample period during which useful images of aquatic organisms 104 in enclosure 102 can be captured. For example, depending on the current season (e.g., winter), time of day (e.g., sunrise or sunset), and latitude of enclosure 102, only a few hours during the middle of the day can be suitable for capturing useful images without using ambient lighting. This daily period can be extended with ambient lighting. Use of fluorescent, LED, or other artificial lighting is also possible.

Mechanical feed system 110 can be connected to or nearby enclosure 102. Feed system 110 can deliver feed via a set of one or more pipes in doses to aquatic organisms in enclosure 102. The set of pipes can be configured to dispense feed on water surface 122 as depicted in FIG. 1. Alternatively, the opening of the set of pipes can be immersed under water surface 122 so that feed is dispensed under water surface 122. Feed system 110 can include components such as a feed blower connected to an air cooler which is connected to an air controller and a feed doser which is connected to a feed selector that is connected to pipes to enclosure 106. The feed doser and the feed selector can be components of feed controller 118.

In operation, adaptive feeding computer system 108 can be programmed or configured to receive sensor data 114 produced by set of sensors 106 via data communication channel 114. System 108 can be programmed or configured to generate feed selection data 116 based on the received sensor data 114. System 108 can be programmed or configured to send feed selection data 116 via data communication channel 120 to feed controller 118. Data communications channel 120 can include one or more of any suitable wired or wireless data communication channels such as, for example, the Internet, ETHERNET, USB, FIREWIRE, CAN-BUS, or other wired data communication technology, or 2G, 3G, 4G, 5G, LTE, WI-FI, WIMAX, BLUETOOTH, satellite-based, or other wireless data communication technology.

Feed controller 118 can be programmed or configured to receive feed selection data 116 from system 108. In response, feed controller 118 can be programmed or configured to select and dispense amounts of one or more feed materials 124. Different types of feed materials 124 can be segregated in different feed bins as shown in FIG. 1. Feed materials 124 can have different nutrition contents and can be in different sizes (e.g., small, medium, or large pellets), different forms (e.g., dried round pellets, pellets with different sink rates, dried flakes, wet paste, etc.), different nutritional formulation (e.g., high protein pellets, high lipid pellets, high vitamin pellets, medicated pellets, etc.). Mechanical feed system 110 can be configured with a mixer that mixes amounts of two or more feed materials 124 at specific ratios into an overall feed mixture that is dispensed into enclosure 102. Alternatively, the amounts of the two or more feed materials 124 can be dispensed separately into enclosure 102, at the same time or at different times. In any case, feed selection data 116 can indicate one or more feed materials 124 to dispense.

While in some examples there are multiple feed materials 124 available for selection by feed selection data 116, there is only one feed material 124 available for selection by feed selection data 116 in other examples. For example, mechanical feed system 110 might not be configured with a mixer and may be configured with only a single bin for containing a single feed material.

Feed selection data 116 may encompass various information representing a selection of one or more feed materials 124 to dispense. For example, feed selection data 116 can simply identify the one or more selected feed materials to dispense. In this case, the amount of each selected feed material to dispense can be determined by feed controller 118 or otherwise by mechanical feed system 108. Feed selection data 116 can specify an amount of a selected feed material to dispense. Feed selection data 116 can specify a future time at which to dispense a selected feed material.

Adaptive feeding computer system 108 can be programmed or configured to generate feed selection data 116 based on one or more of: (i) current environmental conditions inside and outside of enclosure 102 as reflected, for example, by sensor data 114, (ii) an estimated distribution of aquatic organisms in enclosure 104 over a set of one or more different life cycle stages, (iii) an estimate of energy (calorie) requirements of aquatic organisms in a proximate duration, (iv) a current market price of feed materials 124, (v) an estimated future price of feed materials 104, (vi) a current market price of aquatic organism 104, or (vii) an estimated future market price for the aquatic organisms 104.

Based on feed selection data 116, feed system 110 can mix different feeding materials 124 in different portions. For example, feed selection data 116 can specify a set of different feed materials and specific ratios of the different feed materials in an overall feed mixture.

Based on feed selection data 116, feeding system 110 can dispense the different feed portions at different times. For example, feed selection data 116 can specify or indicate an order in which different feed materials should be dispensed. For example, aquatic organisms 104 can contain a mix of adult aquatic organisms and young aquatic organisms. At feeding time, the adult aquatic organisms may typically feed first by outcompeting the younger aquatic organisms for dispensed feed. Only when most of the adult aquatic organisms are satiated will the younger aquatic organism be able to feed. With this, feed selection data 116 can specify that an amount of high lipid feed should be dispensed first, followed by an amount of high protein feed. The feed selection data 116 can specify a time delay between dispensing the high lipid feed and the high protein feed. Alternatively, system 108 can be configured or programmed to analyze images or video captured by the camera to determine when most of the adult aquatic organisms are satiated. Then, system 108 can send additional feed selection data 116 commanding system 110 to dispense an amount of high protein feed. The amount of high lipid feed and the amount of high protein feed to dispense can be determined by system 108 and specified in feed selection data 116. For example, system 108 can be programmed or configured to analyze images or video captured by the camera to determine a distribution of aquatic organisms 104 according to life cycle stage. The amount of high lipid feed can be selected by system 108 based on the distribution of adult aquatic organisms among aquatic organisms 104 and the amount of high protein feed can be selected by system 108 based on the distribution of young aquatic organisms among aquatic organisms 104.

In some examples, system 108 determines feed selection data 116 based on external feed data 126 in addition to sensor data 114. External feed data 126 can be received from one or more external computer systems. External feed data 126 can include data local weather forecast information for a proximate time period and current or future market pricing information of feed materials 124 and aquatic organisms 104. System 108 can use sensor data 114 along with external feed data 116 to determine feed selection data 116 including the relative portions of feed materials 124 to dispense into enclosure 102 at a next feeding time based on the needs of aquatic organisms 104 at current estimated life cycle stages, market expectation of animal nutrition, the time of day, seasons, amount of day light hours, etc.

For example, aquatic organisms 104 may increase the amount of feed consumed when the temperature of the water in enclosure 104 is relatively high or the oxygen saturation level of the water in enclosure is relatively high. In this case, system 108 can be programmed or configured to increase the amount of feed dispensed at a next feeding time as specified by generated feed selection data 116 sent to feed system 110 when the water temperature or dissolved oxygen as indicated by sensor data 114 is relatively high. However, if the water temperature is above an upper limit or below a lower limit, aquatic organisms 104 may stop feeding completely. In this case, system 108 can be programmed or configured to decrease or stop feed at a next feeding time as specified by generated feed selection data 116 sent to feed system 110 while the water temperature is above or below a respective threshold.

Forecasted weather and current water temperature may also be used to determine feed mixture data 116. If the feeding system 108 receives external feed data 126 that indicates that a cold or warm front will approach the vicinity of enclosure 102 in the next few days and sensor data 114 indicates that the water temperature in enclosure 102 may be too low or too high for feeding for the next few days, then feeding system 108 can generate feed mixture data 116 that increases lipid content of the feed at a next feeding time so that aquatic organisms 104 can increase their energy storage for the next few days before the weather front arrives and causes the water temperature to drop or rise.

Young aquatic organisms 104 may require more protein for growth relative to adult aquatic organisms 104. As young aquatic organisms 104 grow over time as detected by sensor data 114, system 108 can adjust the feed dispensed by feed system 110 to include more lipid content and less protein content over that time. System 108 can generate feed selection data 116 over that time to gradually mix in more high lipid feed with less high protein feed over the time, to ease the transition for aquatic organisms 104 as they grow from young to adult. Adult aquatic organisms 104 may also consume more feed. Feeding system 108 can increase the total amount of feed dispensed over time as aquatic organisms 104 grow as determined from sensor data 114.

Aquatic organisms 104 may feed mostly during the day and in the summer but may switch to mostly nighttime or low light feeding during the winter. System 108 can also account for season and day light hours to determine when to feed during a proximate time period (e.g., a specific day).

Market expectation of animal nutrition, animal size, and delivery date can be used by feeding system 108 as a target for animal growth. While adult aquatic organisms 104 may tend to rapidly gain weight growth via mostly lipid intake, it may be desirable for the market to have aquatic organisms 104 with more protein-based growth. The feeding system 108 can adjust and maintain a lower lipid feed mix for aquatic organisms 104 to achieve leaner output. The market may also have more demand at some holiday seasons. The feeding system 108 can be programmed or configured to determine a feeding schedule for achieving target goals of animal nutrition, animal size, and delivery date, and continuously adjust the feeding schedule over time to compensate for changes due to environmental factors.

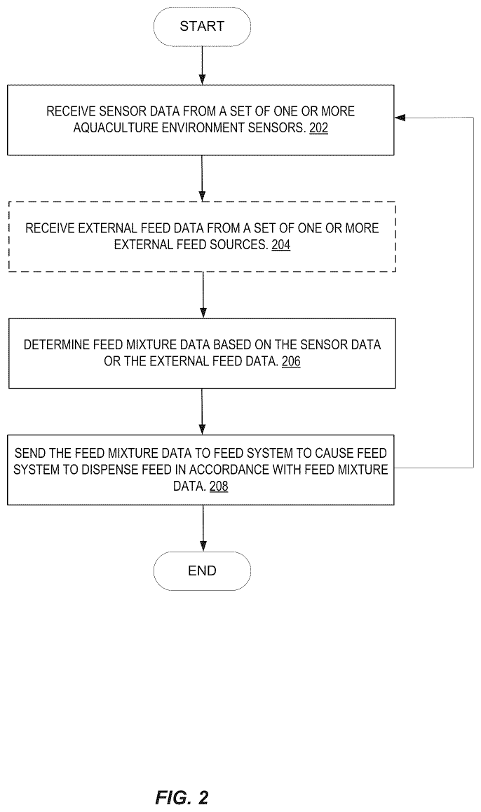

FIG. 2 is a flowchart that illustrates an example of a method of determining an overall feed mixture according to some examples. From a start block, method 700 proceeds to block 702, where adaptive feeding computer system 108 receives sensor data 114 via data communication 112 from sensors 106 in and around enclosure 102. In some examples, sensor data 114 includes at least imagery of aquatic organisms 104 captured by an underwater camera in enclosure 102. Sensor data 114 may include data representing one or more measured aspects of the environment above or below water surface 122 of or near enclosure 102 including water temperature, salinity, chlorophyll, blue-green algae, turbidity, colored dissolved organic matter, air temperature, air temperature, wind speed, wind direction, barometric pressure, or relative humidity.

At optional block 704, adaptive feeding computer system 108 also receives external feed data 126 from one or more external data feed sources. In some examples, external feed data 126 includes at least weather forecast information for an area local to enclosure 102. External feed data 126 may also include current or estimated future market price of feed materials 124 or current or estimated future market price of aquatic organisms 104.

At block 706, system 108 determines feed selection data 116 based on sensor data 114 or external feed data 126. In some examples, system 108 determines feed selection data 116 based on using one or more of: one or more machine learning models, one or more sensor fusion algorithms, or one or more statistical analyzes applied to sensor data 114 or external feed data 126.

At block 708, send 108 sends the generated feed selection data 116 to feed system 110. This causes feed system 110 to dispense amounts of one or more feed materials 124 into enclosure 102 in accordance with feed selection data 116. In some examples, feed selection data 116 specifies or indicates a set of one or more of feed materials 124 to include in an overall feed mixture and an amount of each feed material selected for inclusion in the overall feed mixture. In some examples, feed selection data 116 additionally specifies or indicates an order in which each feed material is to be dispensed into enclosure 102 possibly with a time or time delay indicating or specifying when each feed material is to be dispensed into enclosure 102.

Method 700 can repeat continuously or periodically or in response to an event as new sensor data 114 or new external feed data 126 is received by system 108. Otherwise, method 700 then proceeds an end block and terminates.

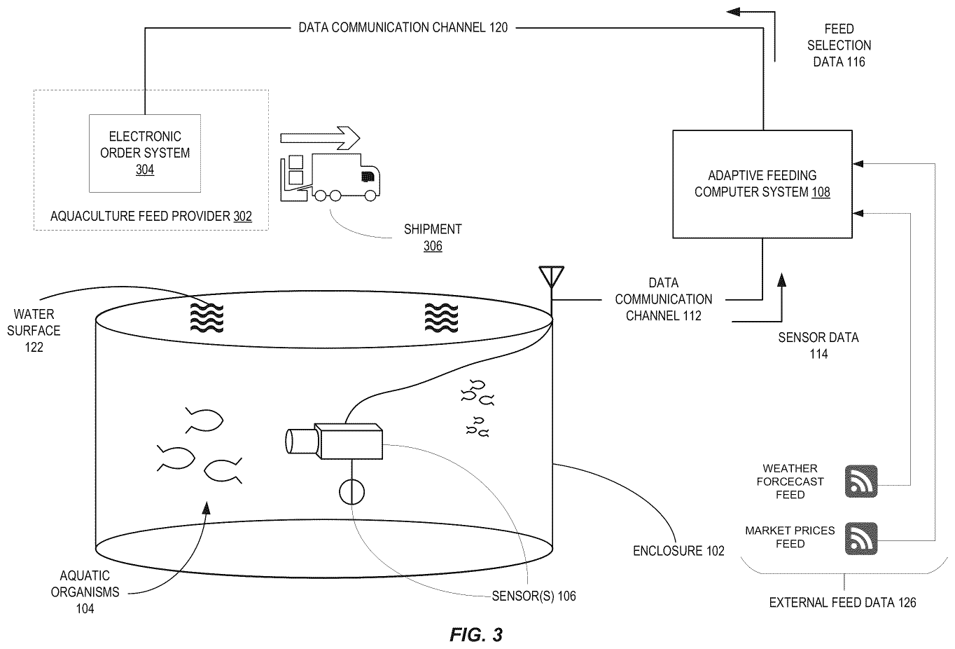

FIG. 3 illustrates an alternative example. In the alternative example, feed selection data 116 is sent via data communication channel 120 to an electronic ordering fulfillment system 304 of an aquaculture food provider 302. Provider 302 prepares an order for shipment 306 in accordance with the feed selection data 116. Shipment 306 is then sent to a farmer (e.g., operator of enclosure 102) or partner or affiliate downstream in the supply chain. In this case, feed selection data 116 can encompass a recipe specifying a set of one or more feed materials, their respective proportions or amounts, instructions for combining the set of feed materials into an overall feed mixture, as well as a desired amount for the overall feed mixture. For example, the instructions can specify whether the overall feed mixture is to be in pellet form or in crumble form, the size of the pellets (e.g., in millimeters), whether the pellet is to be a sinking pellet or floating pellet or a gradation in between that indicates or corresponds to a sink rate of a pellet. A recipe can specify a composition of a pellet in terms of percentage amounts of protein, oil, moisture, fibre, Ash, or digestible energy (e.g., in MJ/kg). The recipe can be determined by adaptive feeding computer system 108 based on sensor data 114. Feed selection data 116 sent to electronic ordering system 304 can specify a feed objective. Aquaculture food provider 302 can then select an overall feed mixture for shipment to meet the feed objective. A feed objective specified in feed selection data 116 might be to increase appetite, to increase growth rate, to shorten production time (e.g., time to harvest), or to support a low feed conversion ratio (FCR).

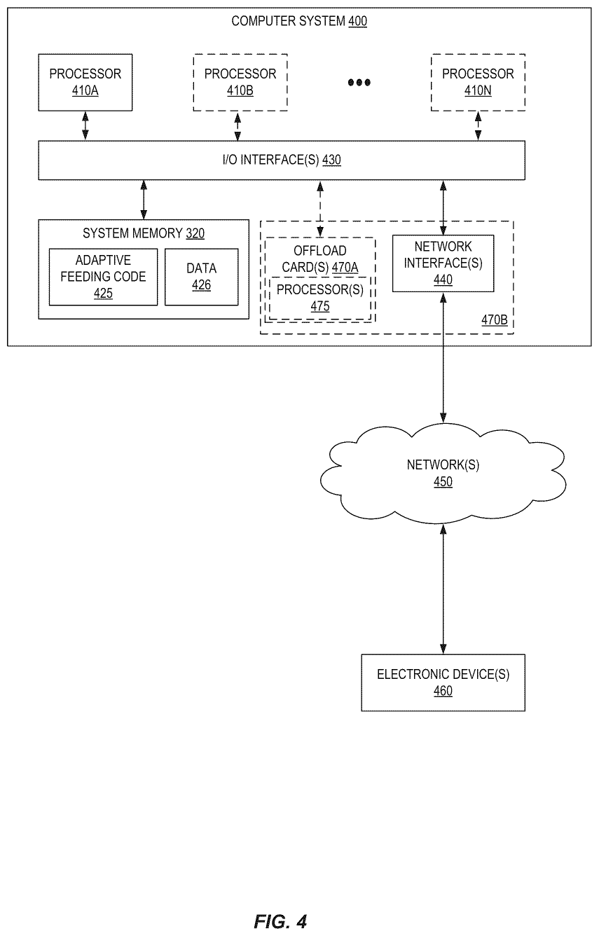

FIG. 4 illustrates computer system 400 that can be used in an implementation adaptive feeding computer system 100 of FIG. 1, according to some examples. Computer system 400 includes one or more processors 410 coupled to system memory 420 via input/output (I/O) interface 430. System 400 further includes network interface 440 coupled to I/O interface 430.

While FIG. 4 shows computer system 400 as a single computing device, in some examples computer system 400 can include one computing device or any number of computing devices configured to work together as single computer system 400 as in a distributed, parallel, or clustered computing system arrangement.

Computer system 400 can be a uniprocessor system including one processor 410, or a multiprocessor system including several processors 410 (e.g., two, four, eight, or another suitable number). Processor(s) 410 can be any suitable processor(s) capable of executing instructions. For example, in various embodiments, processor(s) 410 can be general-purpose or embedded processors implementing any of a variety of instruction set architectures (ISAs), such as the X86, ARM, POWERPC, SPARC, or MIPS ISAs, or any other suitable ISA. In multiprocessor systems, each of processors 410 can commonly, but not necessarily, implement the same ISA.

System memory 420 can store instructions and data accessible by the processor(s) 410. In various embodiments, system memory 420 can be implemented using any suitable memory technology, such as random-access memory (RAM), static RAM (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 420 as adaptive feeding code 425 (e.g., executable to implement, in whole or in part, adaptive feeding computer system 100 of FIG. 1) and data 426.

I/O interface 430 can be configured to coordinate I/O traffic between processor(s) 410, system memory 420, and any peripheral devices in the device, including network interface 440 or other peripheral interfaces (not shown). I/O interface 430 can perform any necessary protocol, timing, or other data transformations to convert data signals from one component (e.g., system memory 420) into a format suitable for use by another component (e.g., processor(s) 410). I/O interface 430 can include support for devices attached through various types of peripheral buses, such as a variant of the PERIPHERAL COMPONENT INTERCONNECT (PCI) bus standard or the UNIVERSAL SERIAL BUS (USB) standard, for example. The function of I/O interface 430 can be split into two or more separate components, such as a north bridge and a south bridge, for example. Also, some or all of the functionality of I/O interface 430, such as an interface to system memory 420, can be incorporated directly into processor 410.

Network interface 440 can be configured to allow data to be exchanged between computer system 400 and other devices 460 attached to network(s) 450, such as other computer systems or devices as illustrated in FIG. 1, for example. Network interface 440 can support communication via any suitable wired or wireless general data networks, such as types of Ethernet network, for example. Additionally, network interface 440 can support communication via telecommunications/telephony networks, such as analog voice networks or digital fiber communications networks, via storage area networks (SANs), such as Fibre Channel SANs, and/or via any other suitable type of network and/or protocol.

Computer system 400 can include one or more offload cards 470A or 470B (including one or more processors 475, and possibly including one or more network interfaces 440) that are connected using I/O interface 430 (e.g., a bus implementing a version of the PERIPHERAL COMPONENT INTERCONNECT-EXPRESS (PCI-E) standard, or another interconnect such as a QUICKPATH INTERCONNECT (QPI) or ULTRAPATH INTERCONNECT (UPI)). For example, computer system 400 can act as a host electronic device (e.g., operating as part of a hardware virtualization service) that hosts compute resources such as compute instances, and one or more offload cards 470A or 470B can execute a virtualization manager that can manage compute instances that execute on the host electronic device. As an example, offload card(s) 470A or 470B can perform compute instance management operations, such as pausing or un-pausing compute instances, launching or terminating compute instances, performing memory transfer/copying operations, etc. These management operations can be performed by offload card(s) 470A or 470B in coordination with a hypervisor (e.g., upon a request from a hypervisor) that is executed by other processors 410A-410N of computer system 400. However, the virtualization manager implemented by offload card(s) 470A or 470B can accommodate requests from other entities (e.g., from compute instances themselves).

System memory 420 is an example of a computer-accessible medium configured to store program instructions and data. However, program instructions or data can be received, sent, or stored upon different types of computer-accessible media. Computer-accessible media includes non-transitory computer-accessible media and computer-accessible transmission media. Examples of non-transitory computer-accessible media includes volatile or non-volatile computer-accessible media. Volatile computer-accessible media includes, for example, most general-purpose random-access memory (RAM) including dynamic RAM (DRAM) and static RAM (SRAM). Non-volatile computer-accessible media includes, for example, semiconductor memory chips capable of storing instructions or data in floating-gate memory cells composed of floating-gate metal-oxide-semiconductor field effect transistors (MOSFETs), including FLASH memory such as NAND flash and solid-state drives (SSD). Other examples of non-volatile computer-accessible media include read-only memory (ROM), erasable programmable ROM (EPROM), electrically erasable programmable ROM (EEPROM), ferroelectric RAM, and other computer data storage devices (e.g., disk storage, hard disks drives, optical discs, floppy disks, and magnetic tape).

Unless the context clearly indicates otherwise, the term “or” is used in the foregoing description and in the appended claims in its inclusive sense (and not in its exclusive sense) so that when used, for example, to connect a list of elements, features, acts, or operations, the term “or” means one, some, or all the elements, features, acts, or operations in the list.

Unless the context clearly indicates otherwise, the terms “comprising,” “including,” “having,” “based on,” “encompassing,” and other like terms, are used in the foregoing description and in the appended claims in an open-ended fashion, and do not exclude additional elements, features, acts, or operations.

Unless the context clearly indicates otherwise, conjunctive language in the foregoing description and in the appending claims such as the phrase “at least one of X, Y, and Z,” is to be understood to convey that an item, term, etc. can be either X, Y, or Z, or a combination thereof. Thus, such conjunctive language is not intended to require by default implication that at least one of X, at least one of Y, and at least one of Z to each be present.

Unless the context clearly indicates otherwise, as used in the foregoing description and in the appended claims, the singular forms “a,” “an,” and “the” are intended to include the plural forms as well.

Unless the context clearly indicates otherwise, in the foregoing description and in the appended claims, although the terms first, second, etc. are, in some instances, used herein to describe various elements, features, acts, or operations, these features, acts, or operations should not be limited by these terms. These terms are only used to distinguish one element, feature, act, or operation from another. For example, a first computing device could be termed a second computing device, and, similarly, a second computing device could be termed a first computing device. The first computing device and the second computing device are both computing devices, but they are not the same computing device.

What is claimed is:

1. A method for adaptive feeding of aquatic organisms in an aquaculture environment, comprising:
receiving sensor data from one or more aquaculture environment sensors, the sensor data reflecting environmental conditions in the aquaculture environment, the aquaculture environment comprising an open water aquatic organism farming enclosure containing aquatic organisms;
determining feed selection data based on the sensor data; and
sending the feed selection data to a feed controller to cause the feed controller to dispense one or more feed materials into the aquaculture environment.

2. The method of claim 1, wherein:
the sensor data comprises images of aquatic organisms in the enclosure captured by a camera immersed underwater in the enclosure; and
determining the feed selection data based on the sensor data comprises:
using a trained convolutional neural network to detect aquatic organisms or dispensed feed in the images captured by the camera,
estimating biomass of the aquatic organisms, growth of the aquatic organisms, or conversion of the dispensed feed detected in the images, and
determining the feed selection data based on the biomass estimate, the growth estimate, or the feed conversion estimate.

3. The method of claim 1, wherein:
the feed selection data represents feed selection information comprising an amount of a feed material, and
sending the feed selection data to the feed controller causes the feed controller to dispense the amount of the feed material.

4. The method of claim 1, wherein:
the feed selection data represents feed selection information comprising a dispense time for a feed material, and
sending the feed selection data to the feed controller causes the feed controller to dispense an amount of the feed material at the dispense time.

5. The method of claim 1, wherein sending the feed selection data to the feed controller cause the feed controller to mix a plurality of feed materials into an overall feed mixture that is dispensed into the aquaculture environment.

6. The method of claim 1, wherein the sensor data reflects underwater sensor information comprising at least one of:
one or more water temperature measurements,
one or more dissolved oxygen measurements,
one or more salinity measurements,
one or more chlorophyll measurements,
one or more blue-green algae measurements,
one or more turbidity measurements, or
one or more colored dissolved organic matter measurements.

7. The method of claim 1, wherein the sensor data reflects above-water sensor information comprising at least one of:
one or more air temperature measurements,
one or more wind speed measurements,
one or more wind direction measurements,
one or more barometric pressure measurements, or
one or more relative humidity measurements.

8. The method of claim 1, further comprising:
receiving external feed data from one or more external data sources, the external feed data comprising weather forecast feed data or market price feed data; and
determining the feed selection data based on the external feed data.

9. A method for adaptive feeding of aquatic organisms in an aquaculture environment, comprising:
receiving sensor data from one or more aquaculture environment sensors, the sensor data reflecting environmental conditions in the aquaculture environment, the aquaculture environment comprising an open water aquatic organism farming enclosure containing aquatic organisms;
determining feed selection data based on the sensor data; and
sending the feed selection data to an electronic feed ordering system to cause an aquaculture feed provider to ship a feed material in accordance with the feed selection data.

10. The method of claim 9, wherein the feed selection data reflects feed selection information comprising an identification of the feed material.

11. The method of claim 9, wherein the feed selection data reflects feed selection information comprising a percentage amount of protein, oil, moisture, fibre, ash, or digestible energy for a feed pellet.

12. A system for adaptive feeding of aquatic organisms in an aquaculture environment, the system comprising:
one or more computing devices to implement an adaptive feeding computer system, the adaptive feeding computer system comprising instructions which when executed cause the adaptive feeding computer system to:
receive sensor data from one or more aquaculture environment sensors, the sensor data reflecting environmental conditions in the aquaculture environment, the aquaculture environment comprising an open water aquatic organism farming enclosure containing aquatic organisms;
determine feed selection data based on the sensor data; and
send the feed selection data to a feed controller to cause the feed controller to dispense one or more feed materials into the aquaculture environment.

13. The system of claim 12, wherein:
the sensor data comprises images of aquatic organisms in the enclosure captured by a camera immersed underwater in the enclosure; and
the instructions which when executed cause the adaptive feeding computer system to determine the feed selection data based on the sensor data comprises instructions which when executed cause the adaptive feeding computer system to:
use a trained convolutional neural network to detect aquatic organisms or dispensed feed in the images captured by the camera,
estimate biomass of the aquatic organisms, growth of the aquatic organisms, or conversion of the dispensed feed detected in the images, and
determine the feed selection data based on the biomass estimate, the growth estimate, or the feed conversion estimate.

14. The system of claim 12, wherein:
the feed selection data represents feed selection information comprising an amount of a feed material, and
the instructions which when executed cause the adaptive feeding computer system to send the feed selection data to the feed controller to cause the feed controller to dispense the amount of the feed material.

15. The system of claim 12, wherein:
the feed selection data represents feed selection information comprising a dispense time for a feed material, and
the instructions which when executed cause the adaptive feeding computer system to send the feed selection data to the feed controller to cause the feed controller to dispense an amount of the feed material at the dispense time.

16. The system of claim 12, wherein the instructions which when executed cause the adaptive feeding computer system to send the feed selection data to the feed controller cause the feed controller to mix a plurality of feed materials into an overall feed mixture that is dispensed into the aquaculture environment.

17. The system of claim 12, wherein the sensor data reflects underwater sensor information comprising at least one of:
one or more water temperature measurements,
one or more dissolved oxygen measurements,
one or more salinity measurements,
one or more chlorophyll measurements,
one or more blue-green algae measurements,
one or more turbidity measurements, or
one or more colored dissolved organic matter measurements.

18. The system of claim 12, wherein the sensor data reflects above-water sensor information comprising at least one of:
one or more air temperature measurements,
one or more wind speed measurements,
one or more wind direction measurements,
one or more barometric pressure measurements, or
one or more relative humidity measurements.

19. The system of claim 12, wherein the instructions which when executed cause the adaptive feeding computer system to:
receive external feed data from one or more external data sources, the external feed data comprising weather forecast feed data or market price feed data; and
determine the feed selection data based on the external feed data.

20. The system of claim 12, wherein:
the feed selection data represents feed selection information comprising a first amount of a first feed material to dispense at a first time and a second amount of a second feed material to dispense at a second time; and
the instructions which when executed cause the adaptive feeding computer system to send the feed selection data to the feed controller to cause the feed controller to dispense the first amount of the first feed material at the first time and to dispense the second amount of the second material at the second time.
